(19) United States
(12) Patent Application Publication
(10) Pub. No.: US 2006/0240177 A1
(43) Pub. Date: Oct. 26, 2006

(54) Overcoat for dental devices

(76) Inventors: James S. Newkirk, LeRoy, NY (US); Sharmene Syversen, Brockport, NY (US); Mitchell C. Rakus JR., Livonia, NY (US)

Correspondence Address: Mark G. Bocchetti;Patent Legal Staff, Eastman Kodak Company, 343 State Street, Rochester, NY, 14650-2201, US

(21) Appl. No.: 11/110,072

(22) Filed: Apr. 20, 2005

(51) Int. Cl. A61C 13/00; B28B 1/38; C08F 2/46; B05D 3/00

(52) U.S. Cl. 427/2.1; 264/16; 264/305; 427/487

(57) ABSTRACT

A method for fabricating a dental restoration, comprising the steps of: applying a first layer of a material on the dental restoration by spraying or dipping; and curing the first layer by exposing the first layer to a light source.

### FIELD OF THE INVENTION

The invention relates generally to the dental field. More specifically, the invention relates to the fabrication of full or partial dental restorations, including but not limited to, veneers, crowns, inlays, onlays, and bridge structures, hereinafter referred to as dental restorations.

### BACKGROUND OF THE INVENTION

Dentists have attempted to replace missing teeth in patients with metal restorations. To improve the life of the restorations and their aesthetic appeal, an opaque or porcelain coating have been applied to provide a color substantially matching the color of the patient's teeth.

Techniques for applying such a coating and for the fabrication of dental restorations are known. For example, U.S. Pat. No. 5,104,319 (Evans et al.) uses the technique of flame spraying to form a ceramic base layer for a dental restoration. U.S. Pat. No. 4,433,959 (Faunce) is directed to a composite laminate dental veneer for attachment to an etched labial enamel surface of a human tooth. U.S. Pat. No. 4,745,961 (Salandra) describes a process of fabricating a dental model by spraying an unhardened and porous refractory model with a particular non-viscous solution. EP 0 364 281 A2 relates to a spray opaque composition for coating restorations and dental appliances.

While such systems may have achieved certain degrees of success in their particular applications, there is a need for a method and apparatus for providing a dental restoration which is readily manufacturable, durable, and able to be readily applied.

### SUMMARY OF THE INVENTION

An object of the present invention is to provide a method and apparatus for dental restoration.

Another object of the present invention is to provide such a method and apparatus for applying an overcoat to a tooth.

These objects are given only by way of illustrative example, and such objects may be exemplary of one or more embodiments of the invention. Other desirable objectives and advantages inherently achieved by the disclosed invention may occur or become apparent to those skilled in the art. The invention is defined by the appended claims.

According to one aspect of the invention, there is provided a method for fabricating a dental restoration, comprising the steps of: applying a first layer of a spray material on the dental restoration by spray atomization using, for example, an airbrush or spray guns; and curing the first layer by exposing the first layer to a light source or microwave curing. More than one layer may be applied.

According to a second aspect of the invention, there is provided a method for fabricating a dental restoration, comprising the steps of: applying a first layer of a coating material on the dental restoration by dip coating, with or without a vacuum, and curing the first layer by exposing the first layer to a light source. More than one layer may be applied and a color gradient established on the tooth.

### BRIEF DESCRIPTION OF THE DRAWINGS

The foregoing and other objects, features, and advantages of the invention will be apparent from the following more particular description of the preferred embodiments of the invention, as illustrated in the accompanying drawings.

FIG. 1 shows a schematic diagram of an airbrush suitable for use with the present invention.

FIG. 2 shows a schematic diagram of a fixture for applying an overcoat to a tooth in accordance with the present invention.

FIG. 3 shows a schematic diagram of a fixture for curing an overcast in accordance with the present invention.

FIG. 4 is an image of a set of teeth having color gradients

FIG. 5 is an image of an uncoated gypsum tooth.

FIG. 6 is an image of the tooth of FIG. 5 after coating.

FIG. 7 is an image of an uncoated polymer tooth.

FIG. 8 is an image of the tooth of FIG. 7 after coating.

FIG. 9 shows a statistical plot for Ra for various teeth samples.

### DETAILED DESCRIPTION OF THE INVENTION

The following is a detailed description of the preferred embodiments of the invention, reference being made to the drawings in which the same reference numerals identify the same elements of structure in each of the several figures.

The present invention is directed to a method and apparatus for providing an overcoat for dental restoration, more particularly, to a fabricated tooth. The overcoat provides a suitable smoothness and color such that the tooth may be placed in the mouth as a dental crown. Methods of overcoating that can be used for this application would be a spray technique or a dip coating process. The present invention employs a spray (liquid atomization) or dip coating technique.

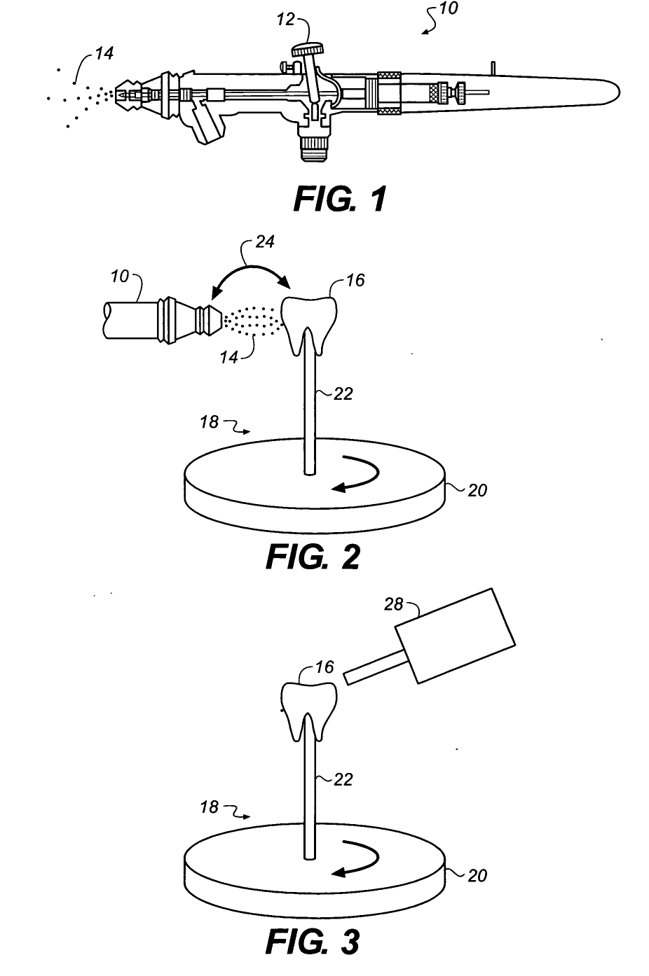

In the present invention, a standard airbrush 10 was employed for applying an overcoat. A schematic diagram of an airbrush 10 is generally shown in FIG. 1. While various airbrushes may be suitable for use with the present invention, a particular airbrush suitable for the present invention the airbrush being an Iwata HP-A model airbrush. This airbrush is referred to as a double action airbrush because there are two finger movements involved in the operation. Pushing down on the trigger 12 releases air and pulling back on the trigger releases paint 14. To spray a fine line for example, the trigger is only slightly drawn back. A heavy spray requires pulling the trigger further back to increase the volume of spray. The air pressure required for this particular airbrush is between about 30 and 45 psi (pounds per square inch).

Referring now to FIG. 2, to apply an overcoat to a fabricated tooth 16, a fixture 18 is employed to hold the tooth. The fixture 18 is shown as a rotatable device turntable 20 which can be rotated, automatically or manually, as the tooth is airbrushed. The rotating turntable comprises an extending member 22, shown as a stick in the middle of the turntable, to which the tooth is attached, for example by glue such as a Loctite adhesive. A putty might alternatively be employed.

The airbrush is moved 24 from the side to the top of the tooth as shown in FIG. 2, as the fixture spins the tooth. It has been determined that the coating can be applied with the airbrush being stationary due to the spray pattern.

After a coating on the tooth is complete, a high-intensity fiber optic light source 28, for example, is used to cure the coating. The light source can be held, as shown in FIG. 3, wherein the tooth is rotated in front of the light source 28. A suitable light source includes one having the following specification: Power 400 W/m²; Wavelength 400-500 nm (peak at 470 nm). An alternate method of curing the coating is use of microwaves.

The coating solutions used for the spray coating of dental crowns are based on a 3M Filtek Z250 formulation used to fill cavities. The 3M Z250 includes a mixture of monomers; Bis-GMA (bisphenol A diglycidyl ether dimethacrylate), UDMA (urethane dimethacrylate, and Bis-EMA (Bisphenol A polyethylene glycol diether dimethacrylate), and inorganic fillers; zirconia and silica. The filler to monomer ratio is about 85/15, which results in a material with a high viscosity (about 350,000 poise), which has the consistency of a paste. Because of the high viscosity, the Z250 paste can be diluted with a suitable solvent (for example, acetone) so that a material with a viscosity suitable for use in an air brushing process results, for example, a material having a viscosity of about 5 to about 20 cP range.

To obtain a detectable range of color, a Tetric Color Stain assortment was obtained from Ivoclar. These stains are based on substantially the same similar monomer composition as the 3M Z250 but without the high amounts of filler and pigments added for color. About 1 to about 2 grams of the “Yellow” stain was added to the 3M Z250 “A1” solution, and about 1 to about 2 grams of the “Dark Brown” stain was added to the 3M Z250 “D3” solution for the color extremes (yellow to brown). To aid in the dissolution of the stains in the 3M Z250 slurries, they were placed in an ultrasonic bath for 5 minutes. A slurry of 3.5 grams of 3M Z250 “B1” shade in 5 grams of acetone was prepared as a neutral “white” color shade. These three solutions provided Applicants with a range of colors that were readily detectable by the human eye in suspension.

The paste cure time is given as about 20 seconds; the acetone and paste material required about 2 minutes cure with the light source, which also provided a mild heat. This mild heat promoted drying the solvent.

A preferred process to obtain a suitable coating is to apply a single, thin layer or mist and then immediately cure with the light source, which also supplies heat. About 4 to 5 spray coats can be employed to build up a final coating. For Applicants, this translated to approximately 10 minute cycle time per tooth.

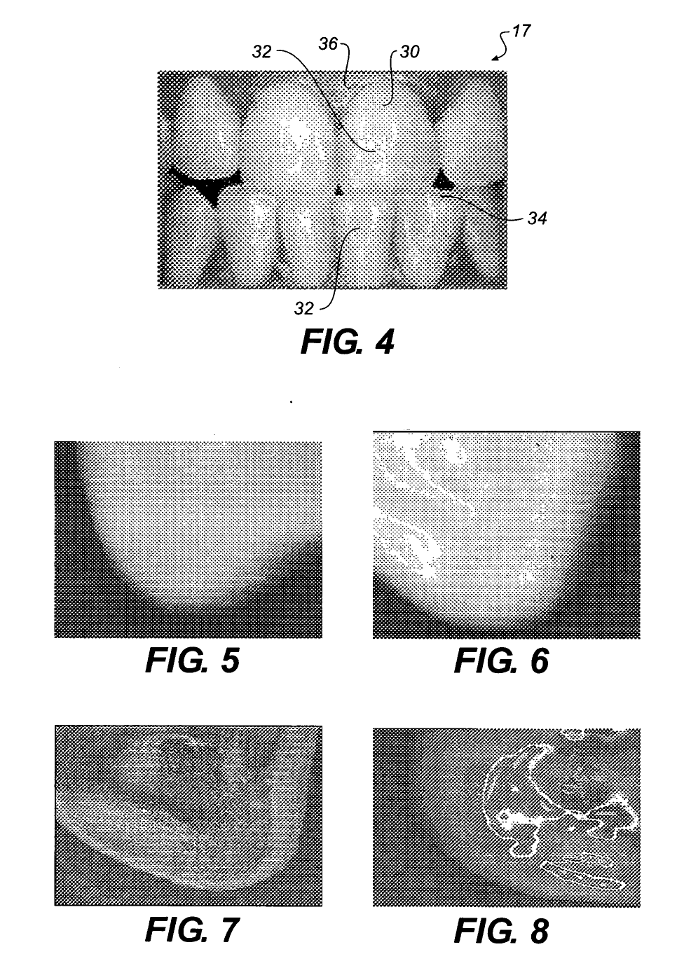

To obtain a preferred realistic color gradient (for example, for anterior teeth), application of several color shades (for example, brown, yellow, and white) might be required. FIG. 4 shows a typical set of teeth 17 with realistic color gradients. The portion of the tooth close to the gums 36 and around the edges might be more yellow or dentin colored 30, then transition to a more white enamel colored 32. Towards the tip of the tooth, furthest away from the gums, the tooth is translucent 34 with slight color. This could be achieved, for example, by applying different shades of dental material (yellow, brown, and white) to create a realistic color gradient on a tooth.

One of the functions of the overcoat is for smoothing, so that the surface is as smooth as a typical ceramic tooth. Surface roughness measurements were made on ceramic teeth, unpolished and polished teeth (of a commercially available system), and uncoated and coated “practice” teeth. Two types of practice teeth were made; gypsum teeth (i.e., white and powdery), and polymer teeth that look deep yellow in color. FIG. 5 shows the gypsum tooth uncoated. FIG. 7 shows the polymer tooth uncoated. The gypsum and polymer teeth were coated with Filtex Z250-3M paste diluted with acetone, 4-5 coats, with 2 minutes of cure and slight heat in between coats. FIGS. 6 and 8 show the coated teeth for the gypsum and polymer, respectively. From the photos, it can be seen that the coated samples visually appear to be smoother.

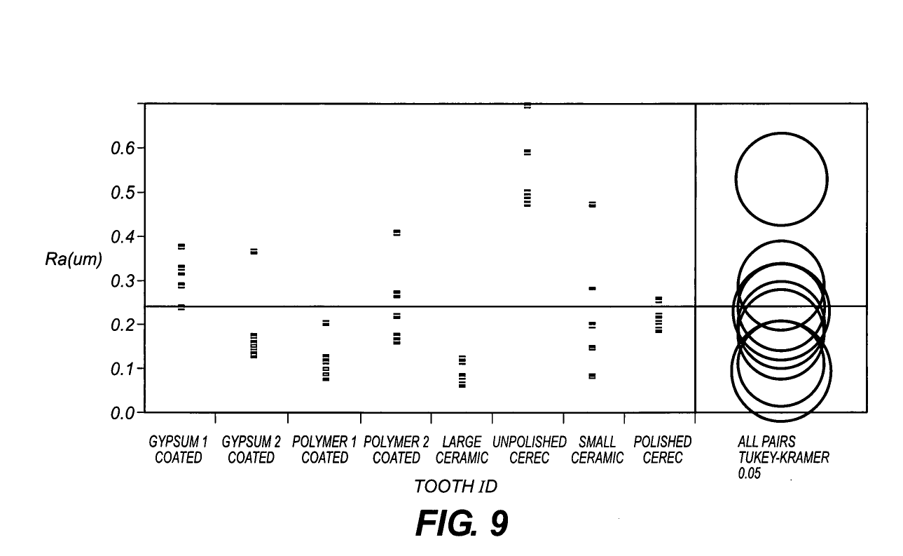

Surface roughness measurements were carried out using a 0.08 mm cutoff filter. The analyses were done using a trace length L of 1.75 mm. FIG. 9 shows the statistical plot for Ra. The plot shows that the unpolished commercially available tooth is statistically different from the coated, ceramic, and commercially polished, teeth. The coated teeth are not statistically different from the ceramic teeth or the commercially polished teeth, therefore this coating technique appears to promote smoothing of the tooth surface.

The invention has been described in detail with particular reference to a presently preferred embodiment, but it will be understood that variations and modifications can be effected within the scope of the invention. The presently disclosed embodiments are therefore considered in all respects to be illustrative and not restrictive. The scope of the invention is indicated by the appended claims, and all changes that come within the meaning and range of equivalents thereof are intended to be embraced therein.

### Parts List

10 airbrush
12 trigger
14 paint
16 tooth
17 teeth
18 fixture
20 turntable
22 extending member
24 arrow
28 fiber optic
30 dentin colored
32 enamel color
34 translucent
36 gum

1. A method for fabricating a dental restoration, comprising the steps of:
applying a first layer of a material on the dental restoration by spraying or dipping; and
curing the first layer by exposing the first layer to a light source.

2. The method of claim 1 further comprising the steps of:
applying a second layer of the material to the dental restoration over the first layer by spraying or dipping; and
curing the second layer by exposing the second layer to the light source.

3. The method of claim 1 wherein the material is comprised of a monomer and/or polymer mixture.

4. The method of claim 1 wherein the material is comprised of a monomer, a polymer, and an inorganic filler.

5. The method of claim 1 wherein the material is comprised of a monomer, a polymer, an inorganic filler, and a solvent.

6. The method of claim 1 wherein the material has a viscosity in the range of about 5 to about 20 cP.

7. A method for fabricating a dental restoration, comprising the steps of:
applying a first layer of a material on the dental restoration by spraying or dipping; and
curing the first layer by exposing the first layer to a microwave source.

8. The method of claim 7 further comprising the steps of:
applying a second layer of the material to the dental restoration over the first layer by spraying or dipping; and
curing the second layer by exposing the second layer to the microwave source.
